(19) United States
(12) Patent Application Publication
(10) Pub. No.: US 2012/0077081 A9
(43) Pub. Date: Mar. 29, 2012

(54) ELECTRODE COMPRISING A MODIFIED COMPLEX OXIDE AS ACTIVE SUBSTANCE

(76) Inventors: Joël Gaubicher, Nantes (FR); Dominique Guyomard, Sautron (FR); Marc Deschamps, Quimper (FR); Bernard Lestriez, Vigoulet Auzil (FR); François Tanguy, Pont L'Abbe (FR)

(21) Appl. No.: 13/122,592

(22) PCT Filed: Oct. 7, 2009
(86) PCT No.: PCT/FR2009/051906

§ 371 Date: Jun. 22, 2011

(30) Foreign Application Priority Data
Oct. 9, 2008 (FR) 0805572

(51) Int. Cl. H01M 4/62; H01M 10/056; H01M 4/26

(52) U.S. Cl. 429/207; 429/212; 29/623.1; 29/623.5

(57) ABSTRACT

An electrode includes an electrically conducting support carrying an electrode material, which has an active substance consisting of particles of a complex oxide which at their surface carry organic phosphorous groups fixed by covalent bonding. The complex oxide may be LiV3O8, LiMn2O4, LiCoO2, LiMPO4 with M=Fe, Mn or Co, Li2MSiO4 with M=Fe, Mn or Co, LiFeBO3, Li4Ti5O12, LiMn2O4, LiNi1−y−zMnyCozAltO2 (0 2O5, MnO2, LiFePO4F, Li3V2(PO4)3, and LiVPO4F. The electrode is useful in particular for lithium batteries.

The present invention relates to an electrode for lithium batteries comprising surface-modified particles of a complex oxide, to a method of manufacture of said electrode, and to a lithium battery comprising said electrode.

It applies typically, but not exclusively, to the areas of lithium metal batteries with dry or jellified polymer electrolyte, notably operating at temperatures of the order of −20° C. to 110° C., lithium metal batteries with liquid electrolyte, and lithium-ion batteries with dry, liquid or jellified polymer electrolyte.

Various complex oxides, for example LiV₃O₈, LiFePO₄ or LiMnO₂, are commonly used as the active substance of an electrode. An oxide of this type generally carries OH groups on its surface, when it is stored in normal conditions, for example in air. It has been found that, in a battery using a complex oxide of this kind as the active substance of an electrode, this oxide can in certain cases cause 15 degradation of the electrolyte of the battery which contains it, and thus reduce its performance. This degradation was attributed to the presence of the oxygen atoms of the —OH groups on the surface of these complex oxides [Cf. notably “The study of surface phenomena related to electrochemical lithium intercalation into LiₓMO_{y} host material” D. Aurbach, et al., Journal of the Electrochemical Society, 147, (4) 1322-1331 (2000)].

It has been proposed to use coating materials in order to create a physical barrier between the material of the electrode and the electrolyte to protect the electrolyte and thus prevent decomposition of said electrolyte by the electrode material. In the case when the conductivity is not mixed, i.e. when the conductivity is either ionic or electronic, the thickness of the coating must be limited and controlling the thickness leads to synthesis protocols that are burdensome and complicated in implementation. In the case when the conductivity is mixed, i.e. when the conductivity is ionic and electronic, it is essential for the physical barrier to be continuous. This barrier can be of inorganic or organic type. An inorganic barrier requires an additional stage of thermal treatment whereas an organic barrier is expensive and difficult to use.

The aim of the present invention is to overcome the drawbacks of the techniques of the prior art notably by proposing an electrode fix a lithium battery that is simple and economical to manufacture, which limits the degradation of the electrolyte in contact with the electrode and has improved cyclability.

The present invention relates to an electrode, notably for lithium batteries, comprising an electrically conducting support carrying an electrode material, characterized in that the electrode material comprises an active substance constituted of particles of a complex oxide which at their surface carry organophosphorus-containing groups fixed by covalent bonding and in that the degree of coverage of the organophosphorus-containing groups on the surface of the particles of complex oxide varies from about 40 to 60%.

“Degree of coverage” means the ratio of the estimated surface concentration to that corresponding to the theoretical maximum for a compact monolayer.

It was found that, surprisingly, when the active substance of the complex oxide type is modified by grafting of a monolayer of organophosphorus-containing groups, and when the degree of coverage of the organophosphorus-containing groups on the surface of the particles of complex oxide is of the order of 40 to 60%, degradation of the electrolyte is suppressed, or at least greatly reduced, despite the is discontinuity of the layer and despite the presence of oxygen atoms. Thus, in contrast to what the prior art teaches, replacement of the hydrogen in the —OH groups on the surface of the particles of complex oxide with organophosphorus-containing groups, with this degree of coverage, has a beneficial influence on the life of the electrolyte.

In a particular embodiment, the degree of coverage of the organophosphorus-containing groups on the surface of the particles of complex oxide is of the order of 50%.

The organophosphorus-containing groups can be:
groups fixed by tridentate grafting [for example RP or (RO)P];
groups fixed by bidentate grafting [for example RP(OR), R₂P or (RO)₂P];
groups fixed by monodentate grafting [for example P(OR)₃, RP(OR)₂, and R₂P(OR)];
   in which the groups R are identical or different groups selected from hydrogen, alkyl groups having from 1 to 10 carbon atoms and phenyl groups, said groups optionally bearing at least one substituent having a function capable of reacting by substitution, addition, condensation or polymerization.

Complex oxide means, in the sense of the present invention, an oxide of lithium and of at least one transition metal. The particles of complex oxide can be selected for example from particles of LiV₃O₈, LiMn₂O₄, LiCoO₂, LiMPO₄ with M=Fe, Mn or Co, Li₂MSiO₄ with M=Fe, Mn or Co, LiFeBO₃, Li₄Ti₅O₁₂, LiMn₂O₄, LiNi_{1-y-z}Mn_{y}Co_{z}AlₜO₂ (0<y<1; 0<z<1; 0<t<1), V₂O₅, MnO₂, LiFePO₄F, Li₃V₂(PO₄)₃, and LiVPO₄F.

Hereinafter,
“unmodified complex oxide” denotes a complex oxide bearing OH groups on its surface, i.e. the complex oxide such as it occurs in normal storage conditions, in the presence of air and/or of moisture;
“modified complex oxide” denotes the material obtained after treatment with a phosphorus-containing reagent, i.e. a complex oxide carrying phosphorus-containing groups as defined above on its surface.

The electrode material according to the present invention can further comprise at least one constituent selected from a material conferring properties of ionic conduction, a material conferring properties of electron conduction, and optionally a material conferring mechanical properties.

The material conferring properties of ionic conduction can be a lithium salt is notably selected from LiClO₄, LiPF₆, LiAsF₆, LiBF₄, LiCF₃SO₃, LiSbF₆, LiFSI or LiTFSI, lithium bisperfluoroalkyl sulfonimides, and lithium bis- or trisperfluorosulfonylmethides.

The material conferring properties of electron conduction can be carbon, preferably selected from carbon blacks such as the compound Ensagri Super S® marketed by the company Chemetals, carbon fibers such as VGCF (“Vapor Grown Carbon Fibers”), and carbon nanotubes, or a mixture thereof.

The material conferring mechanical properties is preferably an organic binder, notably a binder that is electrochemically stable up to a potential of 4.9 V vs Li⁺/Li⁰. This organic binder can be a nonsolvating polymer mixed with at least one polar aprotic compound, or a solvating polymer.

In a preferred embodiment, the electrode material can comprise:
from 50 to 90 wt % of particles of modified complex oxide, preferably 70 wt. %,
from 10 to 30 wt. % of material conferring properties of electron conduction, preferably 30 wt. %, and
optionally, at most 10 wt. % of material conferring mechanical properties.

The conducting support can be a current collector, which is advantageously of aluminum for a positive electrode and of copper for a negative electrode.

Another object of the invention is a method of manufacture of the electrode as described above, characterized in that it comprises stages consisting of preparing a modified complex oxide by reaction of a complex oxide with a phosphorus-containing reagent carrying a group P═O, and of depositing the modified complex oxide obtained on an electrically conducting support.

The thickness of said monolayer is very small, more particularly of the order of 1 nm, and is adjusted to the maximum of the length of the molecular chain(s) of the phosphorus-containing reagent selected. Thus, the electrode according to the invention has no problems relating to charge transfer, i.e. relating to the energy and/or to the kinetics of injection of electrons and ions in the host structure.

In one embodiment, the phosphorus-containing reagent corresponds to the formula R₃₋ₙ(RO)ₙP═O in which n is an integer in the range from 1 to 3 and the groups R have the meaning given previously. We may mention in particular the compounds corresponding to the following formulas:

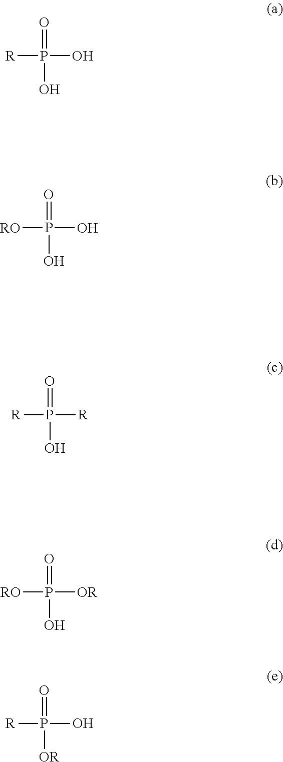

Grafting results either from coordination between the oxygen atom of a group P═O with a metal atom of the complex oxide, or from condensation between an OH group carried by a metal atom of the complex oxide and an OH group carried by the phosphorus-containing reagent. The following scheme illustrates a monodentate grafting (reaction A), a bidentate grafting (reaction B) and a tridentate grafting (reaction C). During enumeration of examples of phosphorus-containing groups grafted on the complex oxide made previously, it is considered that the oxygen atom forms part of the complex oxide.

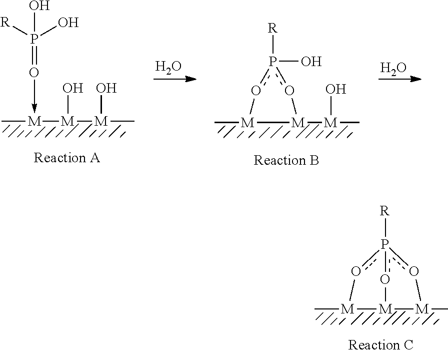

When grafting is performed by means of groups OR in which R is different from hydrogen, the leaving molecule is ROH.

As an example, we may mention, as phosphorus-containing reagent, phenylphosphonic acid (PPO), butyl monophosphate and isopropyl monophosphate.

The concentration of phosphorus-containing reagent in the solution is selected in relation to the specific surface of the unmodified complex oxide (measured by the BET method) and the approximate surface of the phosphorus-containing molecule, determined from geometric considerations. The approximate surface of a phosphorus-containing group can be estimated according to the method described in G. Alberti, M. Casciola, U. Costantino and R. Vivani, Adv. Mater., 1996, 8, 291. According to this method, the free surface (FS) between each P atom in a zirconium phosphate is of the order of 24 Å². Consequently, any group R that is fixed on the P atom perpendicularly to the surface and whose surface of gyration is less than 24 Å² should not, a priori, alter the free surface (FS). Now, in the case of phenylphosphonic acid (PPO), the geometric surface based on the van der Waals radii of the C and H atoms is of the order of 18 Å². The approximate surface is therefore 24 Å².

It is preferable for the amount of phosphorus-containing reagent relative to the amount corresponding to the grafting of a monolayer to be from 1 to 5, and preferably from 1 to 2.

For a given ratio, the degree of coverage depends on the length of time that the phosphorus-containing reagent is in contact with the complex oxide. This length of time is generally between 10 minutes and 5 days. After 10 minutes, about 40% of coverage is reached; after 24 h, from about 50% to 60% and in 1 minute, the degree of coverage is estimated at about 20%. The stage of preparation of the modified complex oxide is preferably carried out for a duration of about 24 hours.

In a particular embodiment, a solution of phosphorus-containing reagent is prepared in a polar or nonpolar solvent in which the complex oxide is stable, for example water or isopropanol, particles of unmodified complex oxide are dispersed in said solution, and it is left, with stirring, then the solid is separated from the liquid, and finally the solid is rinsed with the pure solvent.

Another object of the invention is a lithium battery comprising a positive electrode and a negative electrode separated by an electrolyte comprising a lithium salt in solution in a solvent, the functioning of which is provided by reversible circulation of lithium ions between said electrodes, characterized in that at least one of the electrodes is an electrode as defined according to the present invention. Preferably, the electrode defined according to the present invention is the positive electrode.

A lithium battery can be a so-called “metallic lithium battery” whose negative electrode is constituted of metallic lithium or of a lithium alloy selected for example from the alloys β-LiAl, γ-LiAl, Li—Pb, Li—Cd—Pb, Li—Sn, Li—Sn—Cd, and Li—Sn, and the electrode according to the invention forms the positive electrode. A lithium battery can be a so-called “rocking-chair” or “lithium-ion” battery, in which the positive electrode is an electrode according to the invention and the negative electrode comprises an organic binder and a material capable of reversibly introducing lithium ions at low redox potential.

Other characteristics and advantages of the present invention will become to clear from the examples given below; said examples are given for purposes of illustration and are in no way limiting.

FIG. 1 shows the amount of phosphorus-containing reagent per nm² of complex oxide as a function of the reaction time between the phosphorus-containing reagent and the particles of complex oxide according to the invention.

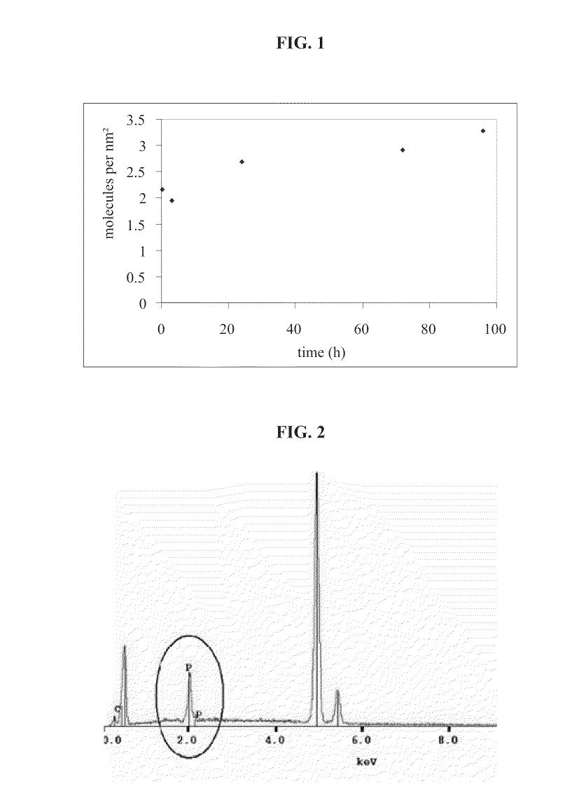

FIG. 2 shows the curve obtained by energy-dispersive X-ray (EDX) spectroscopy of surface-modified particles of a complex oxide, according to the invention.

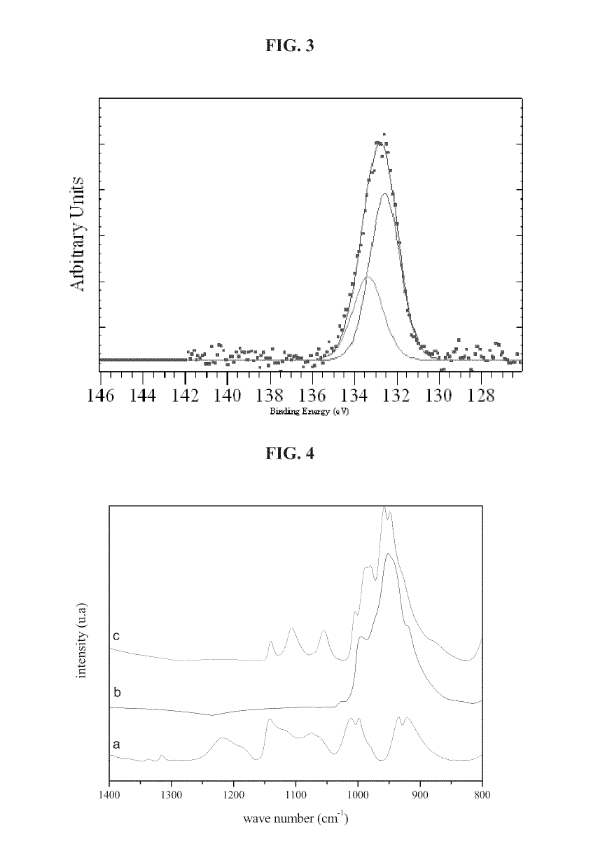

FIG. 3 shows curves obtained by X-ray photoemission spectroscopy (XPS) of the particles from FIG. 2.

FIG. 4 shows infrared spectra of various compounds including the infrared spectrum of the particles from FIG. 2.

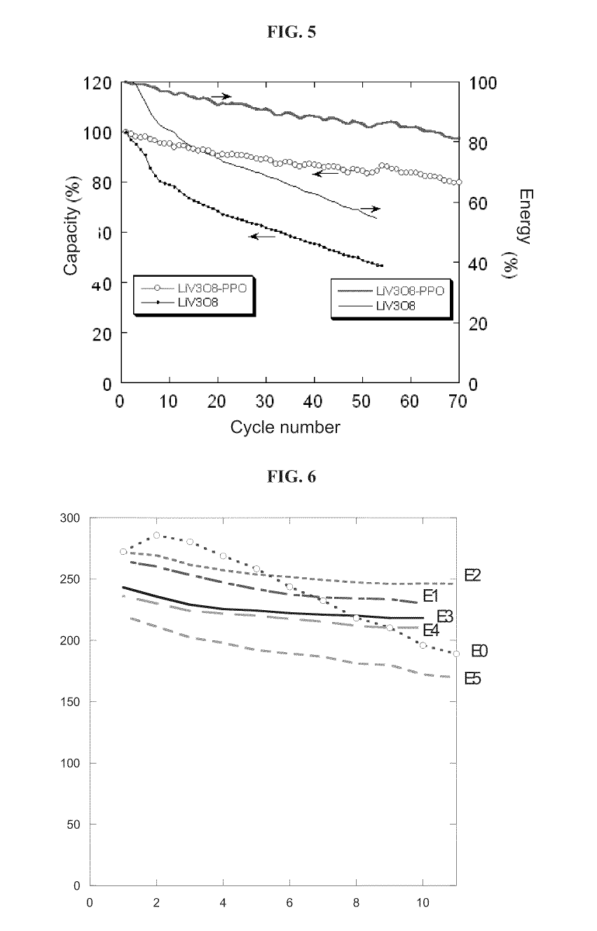

FIG. 5 shows the variation in cyclability as a function of the specific capacity and of the specific energy for an electrode according to the prior art compared with an electrode according to the invention.

FIG. 6 shows the variation in cyclability as a function of the specific capacity and of the specific energy for electrodes made from particles of LiV₃O₈ having different degrees of coverage with PPO groups (0%, 41%, 47%, 51%, 61% and 79%).

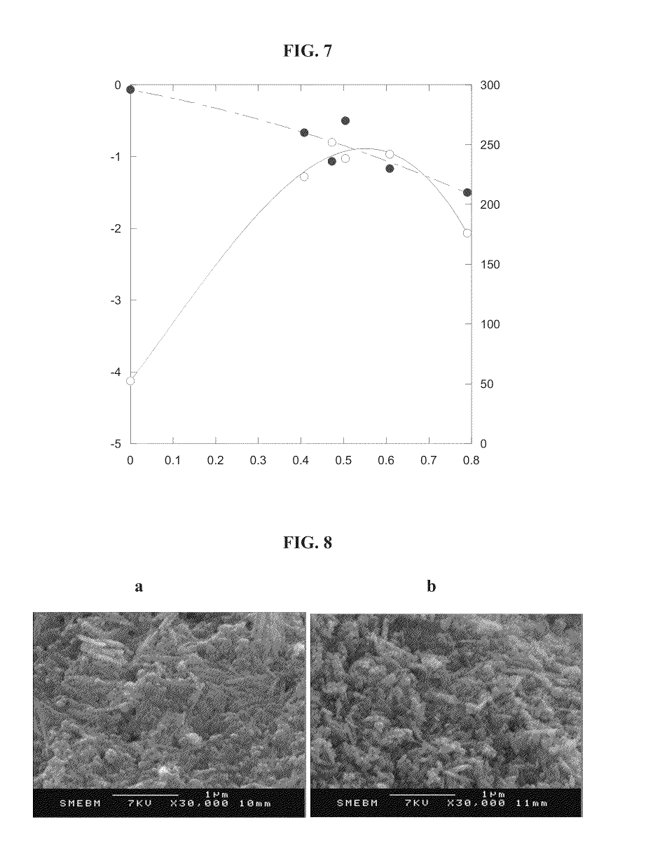

FIG. 7 shows the cyclability of the electrodes tested in FIG. 6 (expressed in percentage loss/cycle; vertical axis on left, curve with open circles) as a function of the degree of coverage (1%), as well as the capacity of the electrodes (expressed in mAh/g; vertical axis on right, curve with filled circles) also as a function of the degree of coverage (11%).

FIG. 8 shows the images obtained by scanning electron microscopy (SEM) of the surface of an electrode according to the prior art (FIG. 8a) and according to the invention (FIG. 8b).

### EXAMPLE

### Preparation of Surface-Modified Particles of a Complex Oxide

An oxide Li₁₊ₓV₃O₈ was used, in which 0.1≦x≦0.25, designated LiV₃O₈ hereinafter.

0.75 g of particles of LiV₃O₈ with specific surface of 38 m²/g was suspended in 20 mL of a 10 mmol.l⁻¹ solution of phenylphosphonic acid (PPO) in isopropanol.

The suspension thus formed was stirred on a magnetic stirrer for 24 h and then recovered, washed with the solvent and dried. Surface-modified particles of complex oxide were obtained, designated LiV₃O₈—PPO.

The surface-modified particles of complex oxide were then washed with isopropanol, submitted to ultrasound for 5 min and centrifuged at 12000 rev/min for 10 minutes. This protocol was repeated three times. We thus obtained LiV₃O₈—PPO, with a degree of coverage of the order of 50%. The washing permitted the removal of species fixed by physisorption (for which (ΔH<20 kJ/mol), so that all the remaining phosphorus-containing groups are fixed by chemisorption (50<ΔH<800 kJ/mol).

The degree of coverage is typically determined by the BET surface ratio of the complex oxide surface-modified with a molecule of PPO, which is about 24 Å². In fact, according to the results of elemental analyses giving the percentages by weight of P on the one hand, and knowing the specific surface of the unmodified complex oxide and the surface of a molecule on the other hand, it is easy to determine the number of phosphorus-containing molecules per unit of surface area. The product obtained was characterized by elemental analysis, by energy-dispersive X-ray (EDX) spectroscopy, by X-ray photoemission spectroscopy (XPS), by infrared (IR), and by X-ray diffraction.

### Elemental Analysis:

Elemental analysis, carried out on the final product obtained after reaction for 24 h, as well as on intermediates, makes it possible to determine the degree of coverage. The variation of the degree of coverage as a function of time is presented in FIG. 1, which shows that after 10 minutes the degree of coverage is 2.1 molecules/nm². The reaction is therefore very rapid. Increasing the reaction time makes it possible to increase the degree of coverage to 3.4 molecules/nm².

### XRD

The results of analysis by X-ray diffraction show that the surface-modified particles of complex oxide LiV₃O₈—PPO are not altered by the grafting process. In fact no new phase is detected and the metric of the modified complex oxide is similar to that of the unmodified complex oxide.

### EDX

Characterization by EDX was carried out using a GEOL 6400 microscope. FIG. 2 relates to the oxide LiV₃O₈ grafted on the surface with PPO, obtained after reaction for 24 hours. It shows the presence of phosphorus on the surface of the particles of complex oxide, the only possible source of which is the phenylphosphonic acid (PPO). The atomic percentage of phosphorus is of the order of 1%.

### XPS Analyses

Characterization by XPS was carried out using a spectrometer of the Kratos Ultra Axis type, on the product obtained after reaction for 24 h.

FIG. 3 shows the XPS spectra of the core electrons of phosphorus P 2p. It can be seen that there is a doublet P 2p 3/2-P 2p ½, located at 132.6-133.4 eV. These bond energies are characteristic of a phosphorus bound to several oxygen atoms and can thus be attributed to groups of the phosphonate type present on the surface of the particles of LiV₃O₈.

### IR Analyses

The infrared spectra of phenylphosphonic acid (PPO) (a), of LiV₃O₈ (b) and of LiV₃O₈—PPO (c) are shown in FIG. 4. The characteristic vibration bands of phenylphosphonic acid (PPO) are shown in Table 1 below.

TABLE 1

| | | |
|---|---|---|
| Vibrations of monosubstituted | ν (═C—H) | 3056 cm⁻¹to 3076 cm⁻¹ |
| benzene | ν (C═C) | 1591 cm⁻¹or 1487 cm⁻¹ |
| | δ (═CH) | 752 cm⁻¹or 693 cm⁻¹ |
| Vibration of the P—C bond | ν (P—C) | 1439 cm⁻¹or 1140 cm⁻¹ |
| Vibration of P═O | ν (P═O) | 1250 cm⁻¹to 1200 cm⁻¹ |
| Vibration of P—OH | ν (P—O) | 1200 cm⁻¹to 900 cm⁻¹ |
| | ν (O—H) | 2700 cm⁻¹to 2560 cm⁻¹, |
| | | 2300 cm⁻¹to 2100 cm⁻¹ |

Phenylphosphonic acid (PPO) has vibrations obtained by Fourier Transform Infrared Spectroscopy (FTIR) that are characteristic of the P—C, P═O and P—OH bonds.

On curve c), corresponding to the modified complex oxide, the band corresponding to the P—C bond can be seen at 1140 cm⁻¹ and that of the phosphoryl bond P═O, which is usually seen at 1220 cm⁻¹, has disappeared, so that it can be stated that there is a strong interaction between the complex oxide LiV₃O₈ and phenylphosphonic acid (PPO). The “P—O-complex oxide” bonds are characterized by the two vibrations at 1107 cm⁻¹ and 1053 cm⁻¹.

These results confirm that the molecules of PPO are grafted on the surface of the particles of LiV₃O₈.

### Example 2

### Method of Manufacture of an Electrode

Particles prepared according to the procedure in example 1 were used as active substance for making an electrode.

The electrode material was prepared by mixing 30 wt. % of carbon and 70 wt. % of the surface-modified particles of complex oxide LiV₃O₈—PPO obtained according to the method in example 1.

The material thus obtained was then deposited on an aluminum sheet, which was to form the current collector.

For comparison, an electrode was prepared according to the same method, using unmodified particles of the complex oxide LiV₃O₈.

The electrochemical properties of the electrodes thus formed were verified by tests performed in standard conditions at room temperature, in a Swagelok® cell marketed by the company Swagelok, in which the electrode to be tested functions as positive electrode, the electrolyte is a 1M solution of LiFP₆ in an ethylene carbonate (EC)/dimethyl carbonate (DMC) 1/1 mixture, and the negative electrode is an electrode of lithium metal.

Discharging and charging were carried out between 3.7 V and 2 V vs. Li⁺/Li⁰ with a current 1 Li/2.5 h (corresponding to introduction of one mole of Li ions per mole of LiV₃O₈ in 2.5 hours) and 1 Li/5 h respectively.

### Influence of Grafting on the Electrochemical Properties

The influence of grafting on the electrochemical properties of a positive electrode was measured using a galvanostat potentiostat of the Mac-Pile type (Biologic its, Claix, France).

In FIG. 5, the curves of specific energy as a function of the number of cycles show the quantity of energy (product of specific capacity by the average potential of the battery) per gram of complex oxide.

The curves of specific capacity as a function of the number of cycles show quantity of charge stored per gram of complex oxide.

The curve of capacity in reduction corresponding to the electrode according to the invention decreases far less after 70 cycles than the curve of capacity in reduction corresponding to the electrode containing unmodified particles of the complex oxide LiV₃O₈ after only 50 cycles. It can also be seen that the electrode according to the invention has, regardless of the number of cycles, higher energy than that of the reference electrode. These results confirm that the use of a modified complex oxide according to the present invention improves the cyclability of the positive electrode.

### Influence of the Degree of Coverage on the Electrochemical Properties

Particles of LiV₃O₈ having degrees of coverage in the range from 41% to 79% were prepared according to the protocol described above in example 1, merely varying the time of immersion of the particles in the 10 mmol.l⁻¹ solution of phenylphosphonic acid (PPO) in isopropanol.

The degrees of coverage thus obtained as a function of time of immersion in PPO solution are given in Table 2 below:

TABLE 2

| Particles | Immersion time | Degree of coverage |
|---|---|---|
| P1 | 5 min | 41% |
| P2 | 10 min | 50% |
| P3 | 60 min | 48% |
| P4 | 24 hours | 61% |
| P5 | 96 hours | 79% |
| P0 | — | 0% |

The particles PO are particles of LiV₃O₈ that were not immersed in the PPO solution, i.e. without any PPO groups on the surface.

Particles of LiV₃O₈ prepared according to the procedure in example 1 and having degrees of coverage in the range from 41% to 79% were used as active substance for making various electrodes.

These various particles were then used for making electrodes according to the method described above in this example (Electrodes E1, E2, E3, E4, E5 and E0 respectively), the electrochemical properties of which were then verified by means of a galvanostat potentiostat of the Mac-Pile type as described previously.

The appended FIG. 6 shows the curves of specific capacity as a function of the number of cycles and represent the quantity of charge stored per gram of complex oxide.

The appended FIG. 7 shows the cyclability of the electrodes (expressed in percentage loss/cycle; vertical axis on left, curve with open circles) as a function of the degree of coverage (%), as well as the capacity of the electrodes (expressed in mAh/g; vertical axis on right, curve with filled circles) also as a function of the degree of coverage (%).

These results show that a degree of coverage between about 40% and 60% is optimal from the standpoint of cyclability and capacity.

### Analysis of the Electrode by Scanning Electron Microscopy (SEM)

The images in FIG. 8 show micrographs, taken by SEM using a GEM, 6400 microscope with a magnification of 30000, of the surface of the electrode based on particles of unmodified LiV₃O₈, after 50 cycles (micrograph on left), and of the surface of an electrode based on particles of LiV₃O₈—PPO, after 70 cycles (micrograph on right).

These images show that the electrode of unmodified oxide has a surface layer after 50 cycles, said layer resulting from decomposition of the electrolyte. In contrast, the electrode based on particles of LiV₃O₈—PPO according to the invention does not have a surface layer, even after 70 cycles. These results confirm that grafting of PPO on the surface of LiV₃O₈ particles prevents degradation of the electrolyte.

1. An electrode comprising:
an electrically conducting support carrying an electrode material, wherein the electrode material includes an active substance constituted of particles of a complex oxide which bear on their surface organophosphorus-containing groups fixed by covalent bonding, and in that the degree of coverage of the organophosphorus-containing groups on the surface of the particles of complex oxide varies from 40 to 60%.

2. The electrode as claimed in claim 1, wherein the degree of coverage of the organophosphorus-containing groups on the surface of the particles of complex oxide is of the order of 50%.

3. The electrode as claimed in claim 1, wherein the organophosphorus-containing groups are fixed by tridentate grafting, by bidentate grafting or by monodentate grafting.

4. The electrode as claimed in claim 1, wherein the organophosphorus-containing groups are selected from the group consisting of RP, (RO)P, RP(OR), R₂P, (RO)₂P, RP(OR)₂, (RO)₃P, R₂P(OR) in which the groups R are identical or different groups selected from hydrogen, alkyl groups having from 1 to 10 carbon atoms and phenyl groups, said groups optionally bearing at least one substituent having a function capable of reacting by substitution, addition, condensation or polymerization.

5. The electrode as claimed in claim 1, wherein the particles of complex oxide are selected from the group of particles consisting of LiV₃O₈, LiMn₂O₄, LiCoO₂, LiMPO₄ with M=Fe, Mn or Co, Li₂MSiO₄ with M=Fe, Mn or Co, LiFeBO₃, Li₄Ti₅O₁₂, LiMn₂O₄, LiNi_{1-y-z}Mn_{y}Co_{z}AlₜO₂ (0<y<1; 0<z<1; 0<t<1), V₂O₅, MnO₂, LiFePO₄F, Li₃V₂(PO₄)₃, and LiVPO₄F.

6. The electrode as claimed in claim 1, wherein the active substance further comprises at least one constituent selected from the group consisting of a material conferring properties of ionic conduction, a material conferring properties of electron conduction, and optionally a material conferring mechanical properties.

7. The electrode as claimed in claim 6, wherein the material conferring properties of ionic conduction is a lithium salt.

8. The electrode as claimed in claim 6, wherein the material conferring properties of electron conduction is carbon.

9. The electrode as claimed in claim 6, wherein the material conferring mechanical properties is an organic binder.

10. The electrode as claimed in claim 6, wherein the electrode material includes from 50 to 90 wt. % of particles of modified complex oxide, from 10 to 30 wt. % of material conferring properties of electron conduction, and optionally at most 10 wt. % of material conferring mechanical properties.

11. The electrode as claimed in claim 9, wherein the electrode material comprises 70 wt. % of particles of modified complex oxide and 30 wt % of material conferring properties of electron conduction.

12. The electrode as claimed in claim 1, wherein the collecting support is a current collector made of aluminum for a positive electrode, and of copper for a negative electrode.

13. A method of manufacture of an electrode as claimed in claim 1, said method having stages consisting of:
preparing a modified complex oxide by reaction of a complex oxide with a phosphorus-containing reagent carrying a group P═O, and of depositing the modified complex oxide obtained on an electrically conducting support.

14. The method as claimed in claim 13 wherein the phosphorus-containing reagent corresponds to the formula R₃₋ₙ(RO)ₙP═O in which n is an integer in the range from 1 to 3, the groups R being groups, which may be identical or different, selected from hydrogen, alkyl groups having from 1 to 10 carbon atoms and phenyl groups, said groups optionally bearing at least one substituent having a function capable of reacting by substitution, addition, condensation or polymerization.

15. The method as claimed in claim 13, wherein the phosphorus-containing reagent is phenylphosphonic acid (PPO).

16. The method as claimed in claim 13, wherein the stage of preparation of the modified complex oxide is carried out for a time of 24 hours.

17. A lithium battery comprising:
a positive electrode; and
a negative electrode separated by an electrolyte including a lithium salt in solution in a solvent, the functioning of which is ensured by reversible circulation of lithium ions between said electrodes, wherein at least one of the electrodes is an electrode as claimed in claim 1.

18. The battery as claimed in claim 17, wherein the electrode defined in claim 1 is the positive electrode.

19. The battery as claimed in claim 18, wherein the negative electrode is constituted of metallic lithium, or of a lithium alloy selected from the group of alloys consisting of β-LiAl, γ-LiAl, Li—Pb, Li—Cd—Pb, Li—Sn, Li—Sn—Cd, and Li—Sn.

20. The battery as claimed in claim 18, wherein the negative electrode comprises an organic binder and a material capable of reversibly introducing lithium ions at low redox potential.
